(19) United States
(12) Patent Application Publication
(10) Pub. No.: US 2013/0094953 A1
(43) Pub. Date: Apr. 18, 2013

(54) VARIABLE THICKNESS AND VARIABLE RADIUS STRUCTURAL RIB SUPPORT FOR SCROLLS AND TORUS

(71) Applicants: Adonis Kosta Spathias, Glendora, CA (US); Razvan Ungureanu, Torrance, CA (US); Darren Duane, Los Angeles, CA (US); Robert Nims, Rancho Palos Verdes, CA (US)

(72) Inventors: Adonis Kosta Spathias, Glendora, CA (US); Razvan Ungureanu, Torrance, CA (US); Darren Duane, Los Angeles, CA (US); Robert Nims, Rancho Palos Verdes, CA (US)

(73) Assignee: HONEYWELL INTERNATIONAL INC., MORRISTOWN, NJ (US)

(21) Appl. No.: 13/271,533

(22) Filed: Oct. 12, 2011

(51) Int. Cl. F04D 29/42; B23P 15/00

(52) U.S. Cl. 415/204; 29/888.024

(57) ABSTRACT

A scroll or torus has a variable thickness and variable radius structure rib support. The scroll or torus may be suitable in high temperature applications while avoiding the high stress found with conventional constant radii ribs and the weight penalty found in stainless steel scrolls and torus. The scroll or torus may be used, for example, on a turbo compressor machine in aircraft environmental control systems.

### BACKGROUND OF THE INVENTION

The present invention relates to apparatus and methods for minimizing stress in structural rib supports on scrolls and torus and, more particularly, to a variable thickness and variable radius structural rib support for scrolls and torus that minimizes stress.

In high temperature applications (for example, about 400 degrees Fahrenheit), the material properties of aluminum degrade. On the turbo compressor machine, the turbine and compressor housings are subject to temperature and pressure that may cause them to fail.

One solution to prevent or delay failure is shown in FIG. 1, where a scroll housing 100 may be made out of stainless steel. This solution, however, often adds weight and cost. To avoid these penalties, an aluminum scroll 110 with thickened walls and ribs 112 may be used, as shown in FIG. 2. The ribs 112 may be used to avoid housing deflection and the housing being over stressed. However, the ribs 112, themselves, can add stress concentrations that cannot be removed by constant fillet radii. This stress can be seen in FIGS. 3 and 4, where the darker gray is used to show the increased stress.

As can be seen, there is a need for a scroll and torus design that may reduce the stress present in conventional designs without suffering a penalty in significant added weight and cost.

### SUMMARY OF THE INVENTION

In one aspect of the present invention, a scroll or torus comprises a plurality of ribs connecting the scroll to a housing, wherein the ribs have a variable fillet radii.

In another aspect of the present invention, a scroll or torus for a turbo compressor machine comprises a plurality of ribs connecting the scroll to a housing, wherein the ribs have a variable fillet radii and a variable thickness.

In a further aspect of the present invention, a method for controlling stress of a scroll or torus mounted on a housing comprises connecting the scroll to the housing with a plurality of ribs; and forming the ribs with a variable fillet radii.

These and other features, aspects and advantages of the present invention will become better understood with reference to the following drawings, description and claims.

### BRIEF DESCRIPTION OF THE DRAWINGS

FIG. 1 is a perspective view of a stainless steel torus housing according to the prior art;

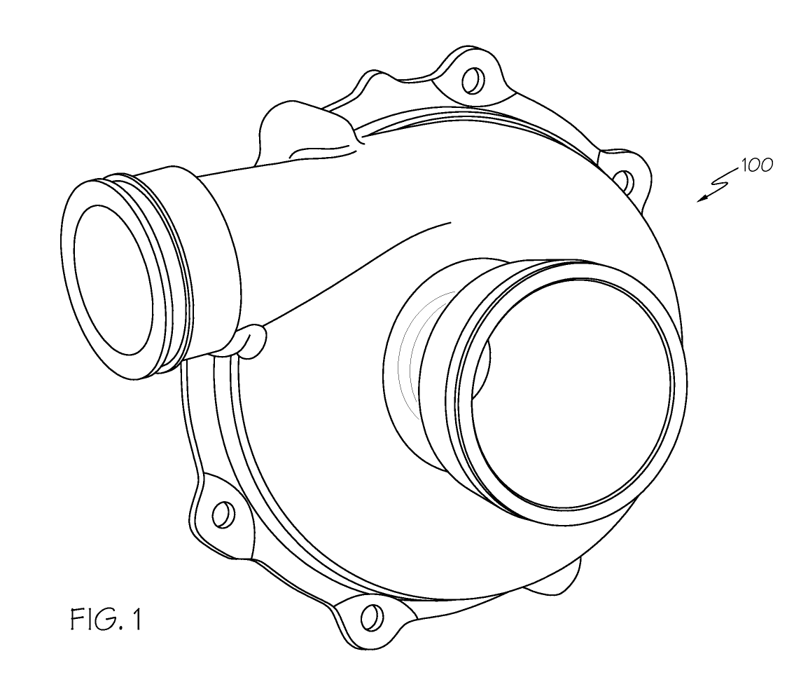

FIG. 2 is a perspective view of an aluminum scroll housing with constant fillet radii ribs according to the prior art;

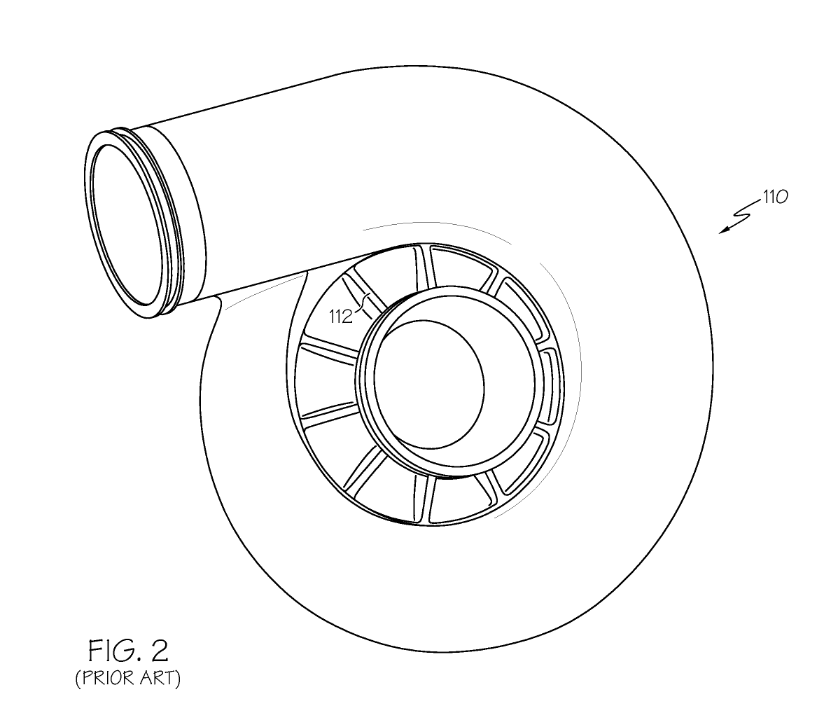

FIG. 3 is a perspective view of the aluminum scroll housing of FIG. 1, showing the stress of the constant fillet radii ribs;

FIG. 4 is a close-up view of the aluminum scroll housing of FIG. 3;

FIG. 5 is a perspective view of a scroll housing having a variable fillet radii according to an exemplary embodiment of the present invention;

FIG. 6 is a close up view of the variable fillet radii of the scroll housing of FIG. 5, showing the stress of the variable fillet radii ribs; and

FIG. 7 is a perspective view of a thick wall aluminum torus having a variable fillet radii ribs according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention provide a scroll or torus having variable thickness and variable radius structure rib support. The scroll or torus of the present invention may be suitable in high temperature applications while avoiding the high stress found with conventional constant radii ribs and the weight penalty found in stainless steel scrolls and torus. The scroll or torus may be used, for example, on a turbo compressor machine in aircraft environmental control systems. As used herein, a “scroll” may generically refer to a scroll, torus, or other similarly designed device.

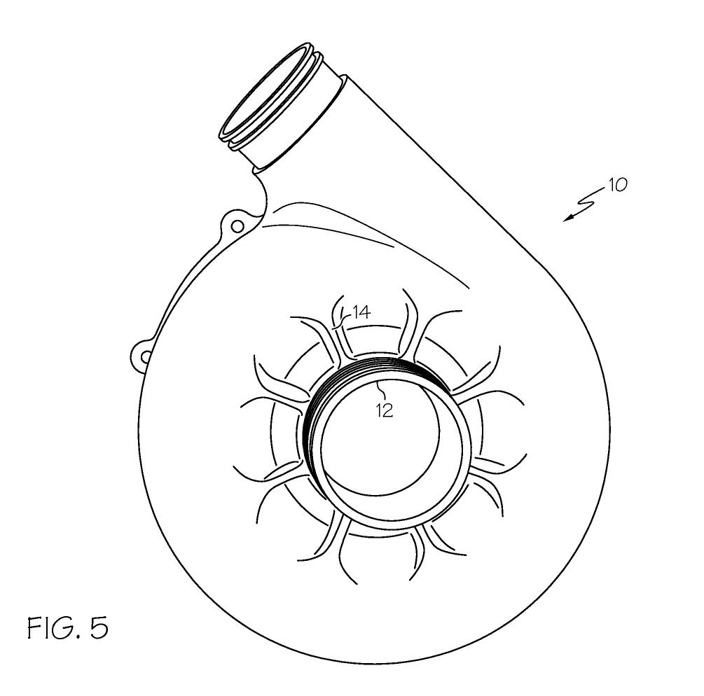

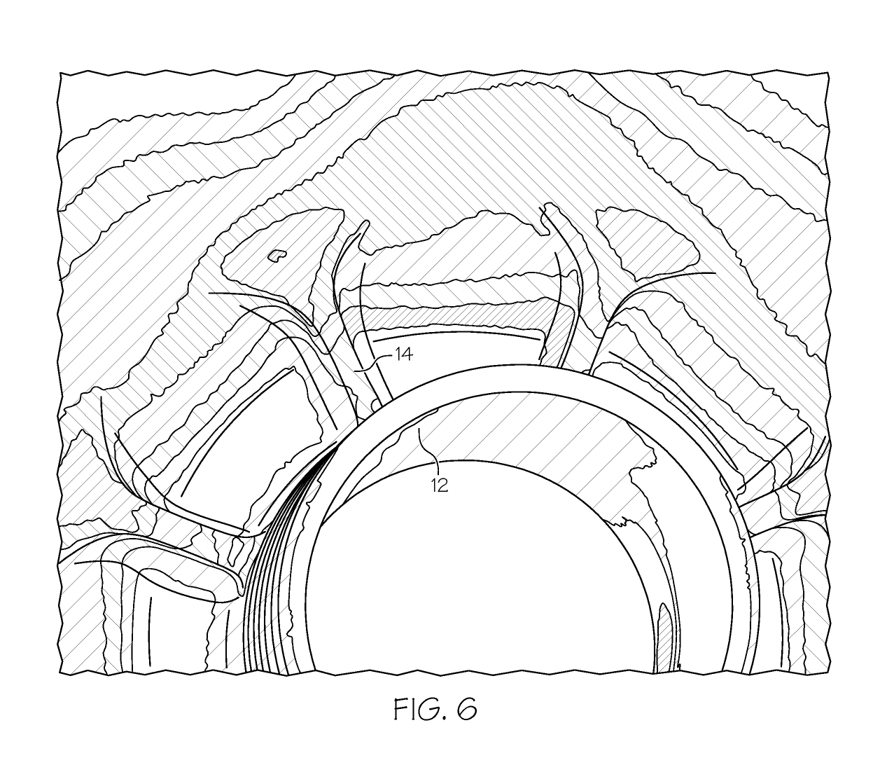

Referring now to FIGS. 5 and 6, a scroll 10 may be supported on a housing 12 by a plurality of ribs 14. The ribs 14 may be disposed about an inside diameter of the scroll 10. The housing 12 may be disposed within the inside diameter of the scroll 10. In some embodiments, from about 4 to about 20 ribs 14 may be disposed between the scroll 10 and the housing 12. The ribs 14 may have a variable fillet radius, as shown in detail in FIG. 6. In some embodiments, the ribs 14 may further include a variable thickness.

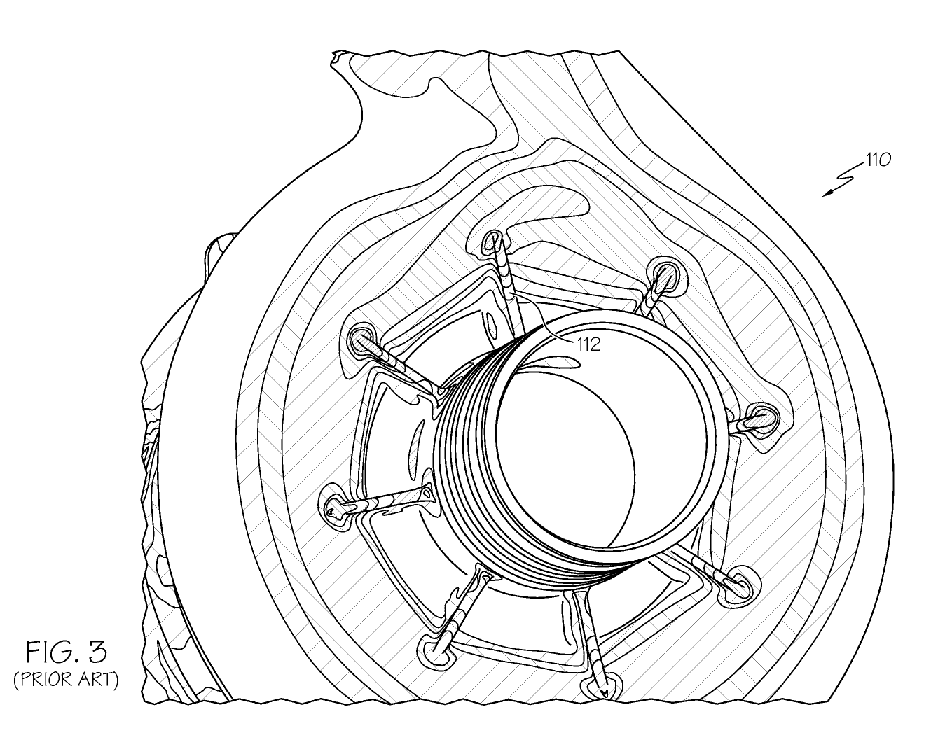

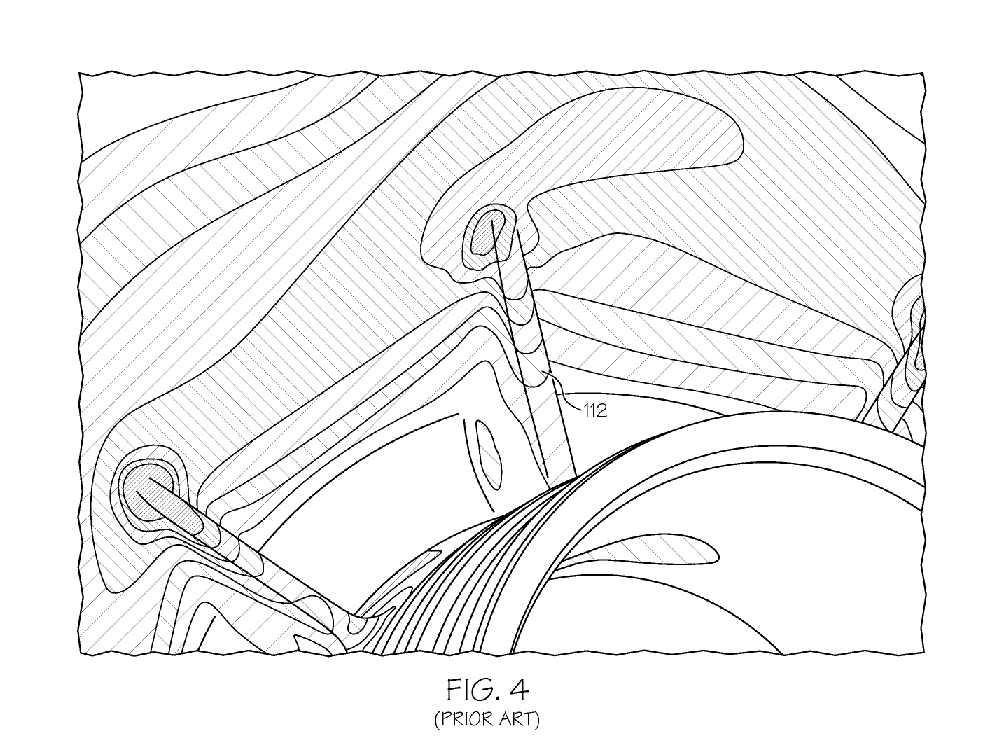

The ribs 14, having the variable fillet radius and, optionally, a variable thickness, may limit the stress between the ribs 14 and the housing 12. This can be seen by the shades of gray shown in FIG. 6, where the darker shades of gray indicate increased stress. The shades of gray used in FIG. 6 correspond to the shades of gray used in FIGS. 3 and 4. As can be seen, the conventional constant fillet ribs show significantly increased stress (shown by darker gray), as compared to the variable fillet radii ribs of the present invention, especially at the location where the ribs connect to the scroll. This decrease in stress may prolong the life and prevent failure of the scroll.

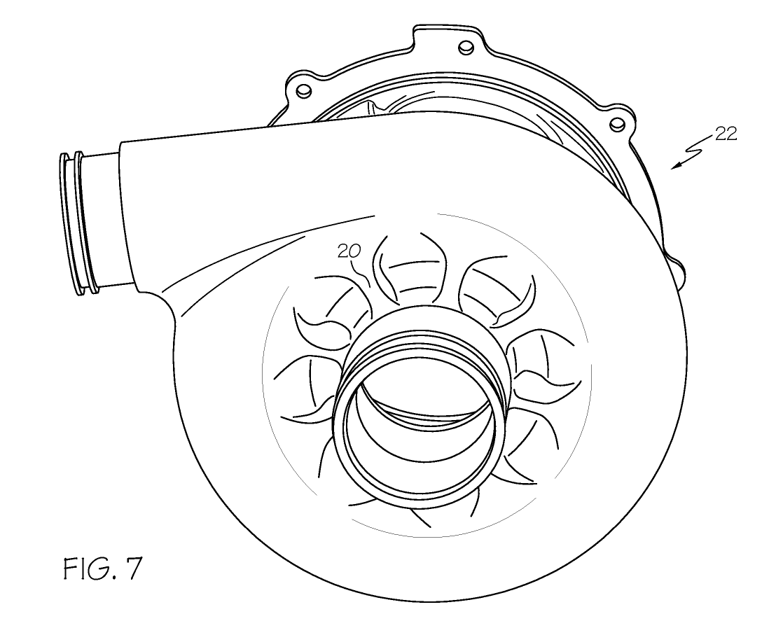

Referring now to FIG. 7, variable fillet radii ribs 20 may be formed in a scroll 22 with a relative complex geometry. In some embodiments, sand and investment casting may be used to manufacture the complex geometries of the scroll 22 and the variable fillet radii ribs 20. This method may provide an inexpensive and repetitive way to make complicated geometric forms.

It should be understood, of course, that the foregoing relates to exemplary embodiments of the invention and that modifications may be made without departing from the spirit and scope of the invention as set forth in the following claims.

We claim:

1. A scroll or torus comprising:
a plurality of ribs connecting the scroll or torus to a housing, wherein the ribs have a variable fillet radii.

2. The scroll or torus of claim 1, wherein the ribs have a variable thickness.

3. The scroll or torus of claim 1, wherein the housing is disposed within an inside diameter of the scroll or torus.

4. The scroll or torus of claim 1, wherein the plurality of ribs includes from about 4 to about 20 ribs.

5. A scroll or torus for a turbo compressor machine, the scroll or torus comprising a plurality of ribs connecting the scroll to a housing, wherein the ribs have a variable fillet radii and a variable thickness.

6. The scroll or torus of claim 5, wherein the housing is disposed within an inside diameter of the scroll or torus.

7. The scroll or torus of claim 5, wherein the plurality of ribs includes from about 4 to about 20 ribs.

8. A method for controlling stress of a scroll or torus mounted on a housing, the method comprising:
connecting the scroll or torus to the housing with a plurality of ribs; and
forming the ribs with a variable fillet radii.

9. The method of claim 8, further comprising forming the ribs with a variable thickness.

10. The method of claim 8, wherein the housing is disposed within an inside diameter of the scroll. or torus
